(19) United States
(12) Patent Application Publication
(10) Pub. No.: US 2007/0291104 A1
(43) Pub. Date: Dec. 20, 2007

(54) Systems and methods of capturing high-resolution images of objects

(75) Inventors: Barry Lee Petersen, Castle Rock, CO (US); Li Shen Chan, Tucheng City (TW); Hui Ping Huang, Tucheng City (TW); Chia Ching Chu, Tucheng City (TW); Hou Hsien Lee, Tucheng City (TW); Tsai Te Wang, Tucheng City (TW); Chang Jou Li, Tucheng City (TW)

Correspondence Address: LADAS & PARRY, 26 WEST 61ST STREET, NEW YORK, NY, 10023, US

(73) Assignee: WAVETRONEX, INC.

(21) Appl. No.: 11/448,650

(22) Filed: Jun. 7, 2006

(51) Int. Cl. H04N 7/14

(52) U.S. Cl. 348/14.01

(57) ABSTRACT

The invention relates to a system of capturing zoom-in images of an object. The system comprises a pan, tilt, zoom (PTZ) camera for capturing a video stream in view; an image-capture device for extracting and digitizing images from the video stream; an object detector for detecting objects in the images from the image-capture device, determining the locations and sizes of the objects and sending the locations and the sizes of the objects to a selector; the selector for determining one of the objects and sending the location and size of the one of the objects to a assessor; the assessor for determining the trajectories required to both align the one of the objects to the center of the image based on the current location of the one of the objects relative to the center and to maximize the size and resolution of the one of the objects according to the current size of the one of the objects, and for sending the trajectories to a translator; the translator for converting the trajectories into a signal stream with a command format that a camera controller can understand and for sending the converted trajectories to the camera controller; and the camera controller for moving and zooming the PTZ camera according to the signal stream, thereby the PTZ camera moves to center on the one of the objects and captures zoomed-in images of the one of the objects from the video stream.

### FIELD OF THE INVENTION

The present invention relates to video security and, more particularly, to the use of object detection technology combined with automated directional optical zoom cameras to track, obtain, and record high-resolution zoomed-in images of objects such as faces or human figures and the times at which they were captured.

### BACKGROUND OF THE INVENTION

Most automated digital video camera-based security applications that exist today are fixed cameras operating over a broad viewing area. They simply record video streams of the entire scene so that if something happens, there is a record of the activity. More advanced systems have moving cameras that scan a wider area by automatically panning the fixed camera over an extended viewing range using various forms of platforms and motors.

Using pan, tilt and zoom cameras, human operators can survey an area in more detail, and are able to direct cameras in order to capture and record close-up, high-resolution images of the objects of interest. Some of these systems now are very fast and convenient, allowing operators to conduct quite advanced functionality with a joystick and keyboard. However, many applications that require security cameras do not have the luxury of dedicated 24-hour security camera operators every day, and the more basic models of observation and data recording must suffice.

Most systems can already capture images of the desired activity, whether it is criminal, accidental, reconnaissance, etc., at the time that it occurs. Yet, a common complaint from most users of those systems is that although they have images of the action, or perpetrator, the lower-resolution image quality obtained from the wide-angle cameras typically used to survey wide areas prevents clear identification. Digital zoom enhancement cannot recover this original loss of resolution.

In order to rectify this problem, camera and sensor manufacturers provide consumers with higher resolution cameras, which can improve the resolution but often come with higher prices or higher storage requirements and still may be far from the resolution ultimately required for adequate object identification. Additionally, the higher resolution images must be stored continuously instead of only when the activity occurs.

Systems have already been designed for automated positioning of pan, tilt and zoom cameras. The main goal of most of these systems is to face the camera in the direction of the activity. Typical examples are videoconferencing applications, where an audio signal such as a voice (U.S. Pat. No. 6,970,796, U.S. Pat. No. 6,940,540 and U.S. Pat. No. 6,922,206) or a person's face (U.S. Pat. No. 6,680,745) can be used to change the camera direction or track an object. These systems do not address the timing and security issues related to the clarification of identity or source.

Object tracking systems based on motion or faces have also been developed for various purposes. As they currently exist, these systems are designed to help users identify objects in real time, as in a video conference, or to signal a human operator or recording system of a variation in activity, such as a person or car moving across the field of view, or identifying objects left behind, such as left bags. They do not use the activity itself to obtain clearer high-resolution images that may be practically used later for review.

U.S. Pat. No. 6,680,745, entitled “VIDEOCONFERENCING METHOD WITH TRACKING OF FACE AND DYNAMIC BANDWIDTH ALLOCATION,” relates to techniques for using face tracking to locate a face in a video image to help direct a camera toward the person. The main object is to get a facial image that is optimized for videoconferencing applications. It has several disadvantages. Firstly, it merely relates to videoconferencing applications. Secondly, it applies more to bandwidth (i.e., size) reduction than higher resolution image recording. Thirdly, it is not directed at security applications. Fourthly, it does not mention image recording. Fifthly, it fails to describe any apparatus. Sixthly, it fails to describe actual techniques. Seventhly, it is limited to face-detection, not all objects.

U.S. Pat. No. 6,940,540, entitled “SPEAKER DETECTION AND TRACKING USING AUDIOVISUAL DATA,” relates to techniques of object tracking. The techniques utilize two audio signals and optionally video signals to track objects. The techniques have several disadvantages. Firstly, they do not apply directly to faces or other objects. Secondly, audio signals are required to apply the claimed techniques.

U.S. Pat. No. 6,972,787, entitled “SYSTEM AND METHOD FOR TRACKING AN OBJECT WITH MULTIPLE CAMERAS,” relates to a trigger recording system based on camera input, wherein its object is obtained from a secondary camera that can detect invisible signals from the same viewing frame. It has several disadvantages. Firstly, its system is based on both visual and invisible light data. Secondly, its system needs two cameras.

U.S. Pat. No. 6,771,306, entitled “METHOD FOR SELECTING A TARGET IN AN AUTOMATED VIDEO TRACKING SYSTEM,” relates to a system to manually get an object out of a video frame to be tracked and to track said object in subsequent frames, wherein the tracking result can be sent to a camera. It has several disadvantages. Firstly, it does not use automated object detection techniques. Secondly, its techniques are not well defined and would be very hard to realize.

U.S. Pat. No. 6,198,693, entitled “SYSTEM AND METHOD FOR FINDING THE DIRECTION OF A WAVE SOURCE USING AN ARRAY OF SENSORS,” relates to techniques of using an audio sensor array to calculate a position for directing hardware. It has several disadvantages. Firstly, it applies audio data instead of visual data. Secondly, it applies an audio sensor array to calculate a position for directing hardware instead of using object detection.

U.S. Pat. No. 6,922,206, entitled “VIDEOCONFERENCING SYSTEM WITH HORIZONTAL AND VERTICAL MICROPHONE ARRAYS,” relates to techniques of controlling a camera by a signal determined from physical microphone arrays. It has several disadvantages. Firstly, it applies to audio data instead of visual data. Secondly, it applies an audio sensor array to calculate a position for directing hardware instead of object detection.

U.S. Pat. No. 6,970,796, entitled “SYSTEM AND METHOD FOR IMPROVING THE PRECISION OF LOCALIZATION ESTIMATES,” relates to techniques of adding improvements to existing audio localization techniques to make the systems better. Its disadvantage is that it requires audio, not visual data.

U.S. Pat. No. 6,727,938, entitled “SECURITY SYSTEM WITH MASKABLE MOTION DETECTION AND CAMERA WITH AN ADJUSTABLE FIELD OF VIEW,” relates to a system for masking regions of view for a PTZ camera, wherein masks at different zoom settings may be saved and recalled whenever the camera returns to the appropriate view. It has several disadvantages. Firstly, masks have to be applied to more than the start or “home” position. Secondly, masks have to be defined manually.

U.S. Pat. No. 6,809,760, entitled “CAMERA CONTROL APPARATUS FOR CONTROLLING A PLURALITY OF CAMERAS FOR TRACKING AN OBJECT,” relates to techniques of a control system for tracking objects that travel between the ranges covered by one camera and the next. Its disadvantage is that it concerns with the transfer of tracked objects to other cameras.

U.S. Pat. No. 6,400,996, entitled “ADAPTIVE PATTERN RECOGNITION BASED CONTROL SYSTEM AND METHOD,” tries to predict user functions by using pattern recognition to find flows or predict activity. It has several disadvantages. Firstly, it does not adequately describe the “adaptive” pattern recognition algorithm employed. Secondly, its predictive system would probably not work as described without a more substantial definition of its pattern recognition technology.

U.S. Pat. No. 5,850,470, entitled “NEURAL NETWORK FOR LOCATING AND RECOGNIZING A DEFORMABLE OBJECT,” relates to a Neural Network method (DBNN) for finding deformable objects, such as faces, in a complex scene. It has several disadvantages. Firstly, it is concerned with the object detection method. Secondly, it fails to disclose any hardware application.

U.S. Pat. No. 6,917,719, entitled “METHOD AND APPARATUS FOR REGION-BASED ALLOCATION OF PROCESSING RESOURCES AND CONTROL OF INPUT IMAGE FORMATION,” describes a method for finding which regions in an image are important, so it can control devices or resources for those regions. The method uses audio signals. Its disadvantage is that it is concerned with finding the region of the image by “defining a region of interest” using an audio signal.

U.S. Pat. No. 6,687,386, entitled “OBJECT TRACKING METHOD AND OBJECT TRACKING APPARATUS,” relates to using motion and edge detection techniques to isolate objects from the background. Once the objects are isolated, the system tracks the image using template matching. It has several disadvantages. Firstly, it is fundamentally for tracking instead of for obtaining and recording high-resolution images. Secondly, it is more of a method description for object tracking.

U.S. Pat. No. 6,914,622, entitled “TELECONFERENCING ROBOT WITH SWIVELING VIDEO MONITOR,” uses robot technology to move the monitor to face the speaker. It has several disadvantages. Firstly, its idea is primarily involved with monitor direction, and the movable camera is connected to the monitor base. Secondly, it applies to robots and teleconferencing. Thirdly, it has no direct relationship to generalized object detection or tracking.

U.S. Pat. No. 6,826,284, entitled “METHOD AND APPARATUS FOR PASSIVE ACOUSTIC SOURCE LOCALIZATION FOR VIDEO CAMERA STEERING APPLICATIONS,” relates to a method for locating the position of an acoustic signal in space. It has several disadvantages. Firstly, it relates to audio signals instead of video signals. Secondly, it fails to describe the hardware.

U.S. Pat. Nos. 6,731,334 and 6,707,489, both entitled “AUTOMATIC VOICE TRACKING CAMERA SYSTEM AND METHOD OF OPERATION,” relate to camera positioning devices and methods based on audio signals. They have several disadvantages. Firstly, they relate to audio signals instead of video signals. Secondly, their camera image is related to a direction, not a specific object. Thirdly, they are not related to object detection.

U.S. Pat. No. 6,947,073, entitled “APPARATUS AND METHOD FOR DETECTING A MOVING TARGET,” uses a camera and a computer to generate a reference image that is subtracted from the live image to create a moving target. It relates the images to previous images captured at known step sizes, so they can be appropriately removed. It has several disadvantages. Firstly, its motion detection technique is highly specialized for particular equipment. Secondly, its system operates with step cameras that require calibration.

U.S. Pat. No. 6,567,116, entitled “MULTIPLE OBJECT TRACKING SYSTEM,” tracks objects prepared in advance with paint or ink. Its disadvantage is that its system requires the physical modification of the objects tracked.

U.S. Pat. No. 6,727,935, entitled “SYSTEM AND METHOD FOR SELECTIVELY OBSCURING A VIDEO SIGNAL,” relates to a method for locating the position of an acoustic signal in space. Its disadvantage is that its object detection method requires specialized equipment and double exposures.

U.S. Pat. No. 5,583,565, entitled “METHOD FOR AUTOMATICALLY ADJUSTING THE PAN AND TILT OF A VIDEO CONFERENCING SYSTEM CAMERA,” moves the camera automatically based on user-defined objects. It has the disadvantage that the system requires the object of interest to be selected by the user, which is not the same as if the object is automatically detected by the system.

It is desirable in a video security environment to provide an automated system that can recognize where in a video image an activity occurs, along with its size, so that a higher-resolution image of the activity can be obtained and recorded at that time either with the same or a second optical zoom camera.

### SUMMARY OF THE INVENTION

In view of the foregoing and other problems of the conventional methods, it is, therefore, an object of the present invention to provide a method and device for capturing a high-resolution, zoomed-in image of activity using object-tracking techniques in conjunction with directional optical-zoom cameras.

The method may include obtaining the location of a target object or objects from images withdrawn from a continuous video stream using an object-detection algorithm. The method may also include an object-tracking algorithm. The method may also include using the detected location of the target object to align the camera to the object. The method may also include using the detected size of the object to change an optical zoom function to increase the image resolution for subsequently captured images. The method may be applied to a single camera or a plurality of cameras based on the original targeted object image. The method may be repeated at different levels of magnification for real-time continuous operation. The method will be able to optionally record all high-resolution images until the object size limit or the camera's fully extended zoom limit is reached, or a predetermined timer has expired.

The system will perform the activity described in the method using standard computers, related image-capture hardware, and optical zoom cameras. The system may use directional motors and relevant controls such as pan and tilt features of a standard camera platform or a pan, tilt, zoom (PTZ) camera.

Other objects, advantages and salient features of the present invention will become apparent from the following detailed description taken in conjunction with the annexed drawings, which disclose preferred embodiments of the present invention.

### BRIEF DESCRIPTION OF THE DRAWINGS

FIG. 1 shows a simple flow chart of track-zoom function.

FIG. 2 shows a more detailed version of the process of FIG. 1.

FIG. 3 shows the block diagram of a system according to an embodiment of the present invention for implementing the process as described in FIGS. 1 and 2, wherein the relationships between the components in the system and how the components work together are shown.

FIG. 4, including four different operational configurations as shown in FIGS. 4a to 4d, is a detailed flow chart of the process according to the embodiment of the present invention.

FIG. 5 is a detailed flow chart that shows the process of assignment of one or more systems according to the embodiment of the present invention.

### DETAILED DESCRIPTION OF THE INVENTION

The present invention is described in more detail by referring to the accompanying drawings. The drawings are to describe the preferred embodiments. However, the present invention is exemplified with several embodiments but is not limited by said embodiments. Said embodiments are to disclose the scope of protection of the present invention to persons of ordinary skill in the art in more detail.

### Basic Description of Track-Zoom Function

The track-zoom function is fundamentally the reaction of a directional zoom camera to the detection of an object in a video window. The camera direction and amount of zoom are varied in order to move the object into the center of the image at the largest possible size in relation to the entire video window, or best resolution.

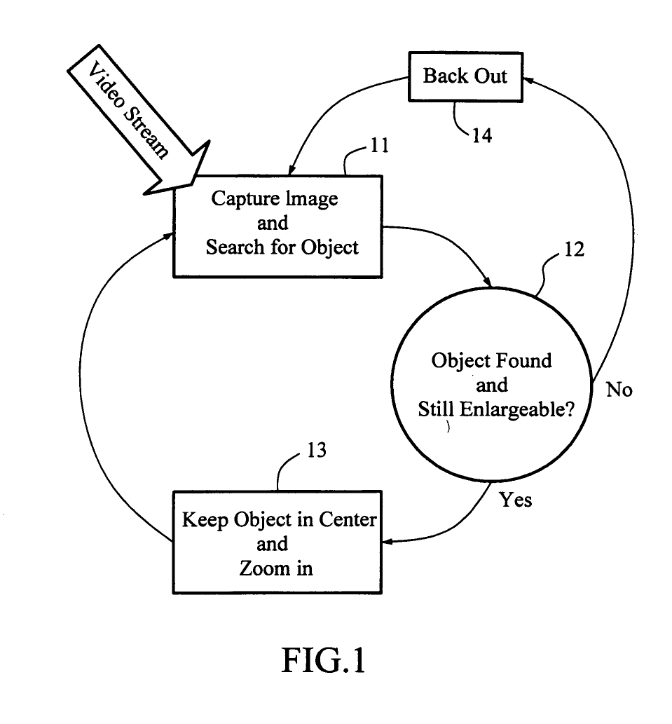

FIG. 1 shows a simple flow chart of the track-zoom function. The process captures images in a video stream with a pan, tilt, zoom (PTZ) camera, or a zoom camera mounted on a pan/tilt platform, and applies an object detection algorithm to the captured image so as to search for an object 11. If an object is found and is still enlargeable 12, the system commands the PTZ camera to center the object and slowly increase the optical zoom iteratively 13, as shown in FIG. 1. If no object is found, the object is missing, or when the maximized object image is obtained, the iteration stops, the PTZ camera backs out (i.e., returns to its original or “home” position) 14, and the process returns to an idle mode. The process can repeat continuously. If multiple objects are detected, the process selectively captures images of the different objects in successive steps or successive cycles.

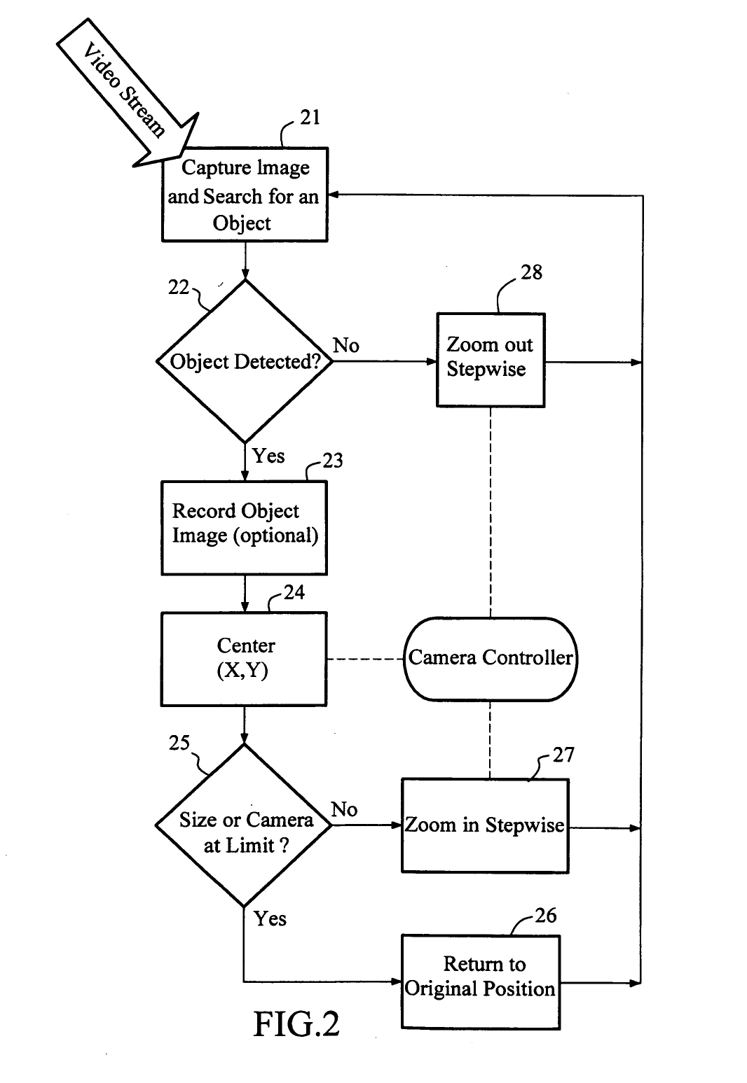

FIG. 2 shows the process of FIG. 1 with more detail. The image is obtained and scanned for an object 21, and the presence of an object 22 triggers the optional recording of the image 23 and the calls to the PTZ camera to center 24 and zoom in on the object 27. If no object is present, this results in a call to zoom out the PTZ camera 28. When the object size limit or the PTZ camera full-zoom extension is reached 25, the PTZ camera zooms out as necessary and returns to its original or “home” position 26, and the system returns to idle. In this figure, the relationship between the centering 24, zooming in 27, zooming out 28, and returning to its original position 26 functions and the camera motor controller are clearly delineated.

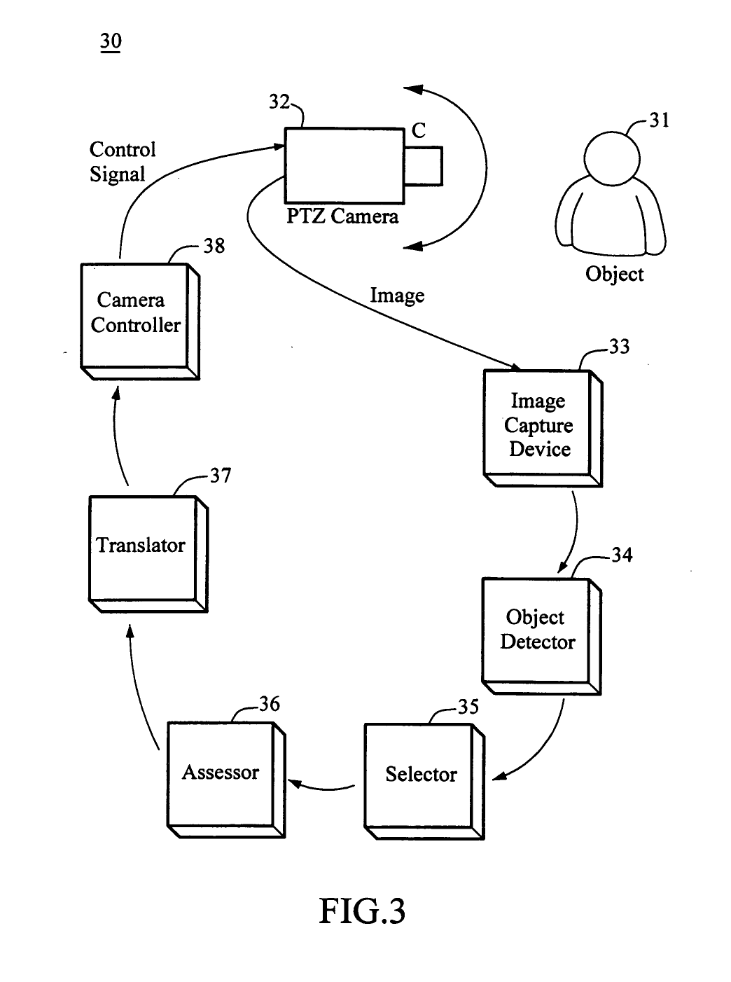

FIG. 3 shows the relationships between the components in a system 30 for implementing the process as described in FIGS. 1 and 2, and how the components work together. The system 30 comprises: a PTZ camera 32 for capturing a video stream in view; an image-capture device 33 for extracting and digitizing the images from the video stream; an object detector 34 for getting the images from the image-capture device 33, detecting size(s) and location(s) of any objects in the image 31 to a selector 35; the selector 35 for choosing one of the objects 31 and sending the location and the size of the one of the objects 31 to the assessor 36; the assessor 36 for determining trajectories of moving the PTZ camera to center on the object 31 according to the size and the location of the object 31 and to maximize the size and resolution of the object 31 and send the trajectories to a translator 37; the translator 37 for converting the trajectories to a signal stream with a command format and sending the signal stream to a camera controller 38; and the camera controller 38 for moving the PTZ camera 32 according to the signal stream, thereby the PTZ camera 32 moves to center on the one of the objects 31 and captures zoomed-in images of the one of the objects 31 from the video stream.

The PTZ camera 32 is a device capable of producing a constant stream of images, such as a video camera or a continuously activated still-frame camera. The image-capture device 33 is a device capable of removing a single digitized image window from the video stream. The object detector 34 is a device capable of isolating one or more objects 31 from the digitized images. The object detector 34 of the system 30 is interchangeable. Some implementations may use a direct comparison algorithm, like in the case of face-detection, where the object 31 is well defined. One potentially applicable algorithm is described in Turk and Pentland (U.S. Pat. No. 5,164,992 & Reissue 36,041). Other face-detection algorithms or methods described in U.S. Pat. Nos. 6,804,391, 6,792,135, 6,661,907, 6,463,163, 5,835,616 and in Stan Z. Li et al.: “Handbook of Face Recognition,” Springer Science+Business Media, Inc., N.Y., USA, pages 13-37, ISBN: 0-387-40595-X. Direct comparison algorithms or techniques are defined here as any comparison methodology that takes a model, perhaps generalized, of a specific object 31 and uses that model in a direct comparison with other objects to determine if the object in question is similar enough to be considered equivalent. Direct comparison techniques may be used on still images or individual video frames. Other implementations may use motion detection to find objects 31. Motion detection algorithms or techniques are herein defined as a methodology for determining the differences between subsequent frames of a moving sequence and using that differential information to identify the location of a moving object 31 and the coordinates of the associated spatial range wherein motion was detected. Still other implementations may use a combination of either of the above two techniques (direct comparison or motion detection) and a third type of object detector 34 that is trained in real time, such as a template matching algorithm or a neural network. In the third type of object detector, the primary search algorithm identifies the original object 31, but the subsequent detection is done, either primarily or secondarily, based on the characteristics of the actual object 31 first detected or a version previously properly identified. If no such third type of object detector 34 is used, the system defaults to a generalized object detector 34 that detects all similar predefined objects 31 without a preference to any one in particular, however objects that are closest in size and location to the previously detected object 31 in the case where an object 31 was previously detected may be considered the same object. An object 31 may also be predefined sub-regions of areas detected using the object-detector's 34 object detection algorithm, and such sub-regions are just considered an extension of the object-detection algorithm itself. For example, the object 31 eventually sent to the assessor 36 for centering may be the top one-third of a full-person object 31 obtained through motion detection.

The selector 35 is a device capable of isolating a single object 31 from the one or more objects present in the image as determined by the object detector 34, and sending that object's 31 size and location to the assessor 36. The selection functionality of the selector 35 could be implemented in a variable manner, depending on the application. For example, the selector 35 may simply choose the object 31 closest to the center of the image, or the object 31 with the largest size. More advanced selection algorithms could include the application of time-refreshed masks for object 31 selection, wherein an object 31 is selected based on whether or not the object 31 has been previously captured. The algorithm of the selector 35 could also vary depending on the position of the PTZ camera 32 and the current state of the image capturing system 30. For example, the selection algorithm of the selector 35 in the “home” or original camera 32 position (for example, “time-refreshed mask system”) may be different from the selection algorithm utilized when the PTZ camera 32 is zooming in (for example, “object nearest to center”). However, the fundamental functionality of the selector 35 remains the same.

The assessor 36 is a device capable of determining trajectories of moving the PTZ camera 32 to center on the object 31 according to the location of the object 31 and to maximize the size and resolution of the object 31 according to the size of the object 31, and sending the trajectories to a translator 37. The centering function of the assessor 36 could be simple, as in a relative distance from the center of the image to the object 31 location, or more complicated, as for example a predictive algorithm that takes into account previous object 31 positions or trajectories in order to determine the highest probability for the object 31 to be centered in the next image. The translator 37 is a device capable of converting the trajectories into a signal stream with a command format, such as in rectangular coordinates, i.e., in x-, y-, z-axes, or in polar coordinates, that a camera controller can understand and sending the converted trajectories to the camera controller 38. The camera controller 38 provides the signal stream necessary to move the PTZ camera 32 as directed in rectangular, i.e., in x-, y-, z-axes or polar coordinates, and the amount of zoom.

In a similar but alternative embodiment (not shown), a fixed image primary camera, which may or may not also be a PTZ camera, could have its visual field calibrated to that of one or more PTZ cameras of one or more systems as shown in FIG. 3. Then the primary camera could detect objects in the overall field of view, and that information could then be used to direct the PTZ cameras to the detected object(s). In this configuration, the primary camera would act as a master, and all PTZ cameras would be subordinate to directional commands obtained from the primary camera's detected objects. The PTZ cameras of the systems of FIG. 3 could either detect and zoom in on their own objects, or else they could act in a fully subservient manner, only going to where the primary camera detected the object. This configuration would also allow the primary camera to act as a backup in case the PTZ camera system lost the object but the primary camera was still aware of its location. In this case, the primary camera system could direct the PTZ camera during tracking if it lost its object before reaching the expected size or time limit, or else just keep a record of where the object went. Another application would be to use the detected images to redirect the fully or partially zoomed PTZ cameras to other objects at similar distances instead of losing time by having the PTZ cameras return to the home position after they have finished collecting their target image or have lost their target. Alternatively, the primary camera may simply act as a backup system to keep a record of the overall view while the PTZ camera system or systems are tracking the objects independently. In this way, if more than one object is present, different PTZ cameras may be sent out to track different objects at the same time. Although these types of systems are more complex, the fundamental system driving the individual and combination of cameras is the same.

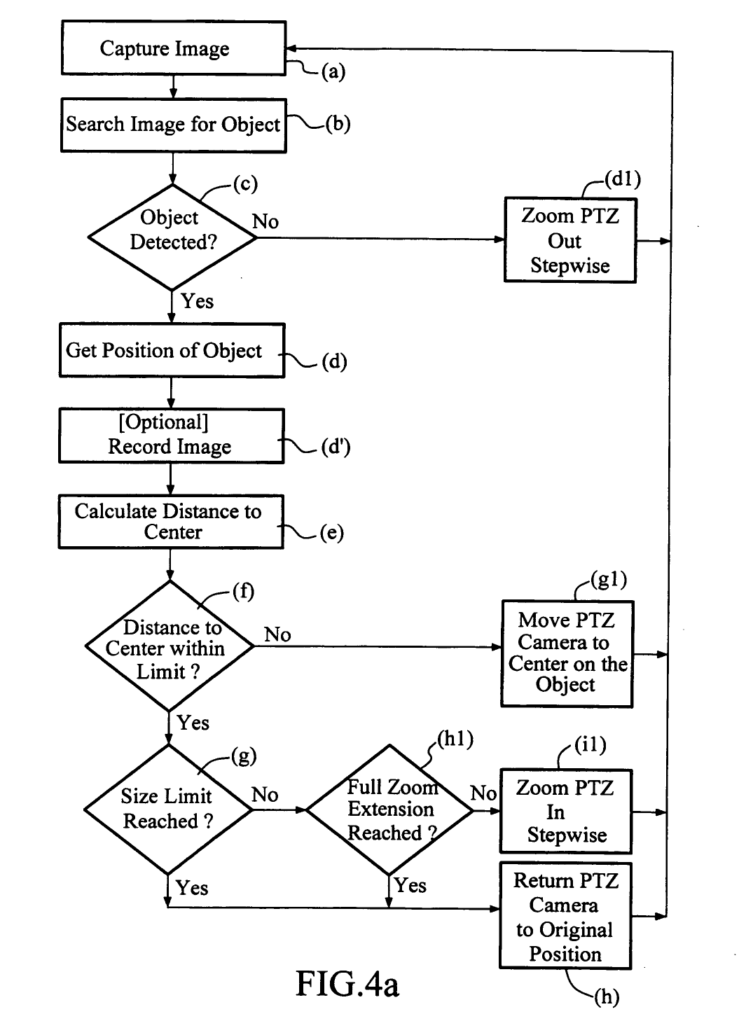

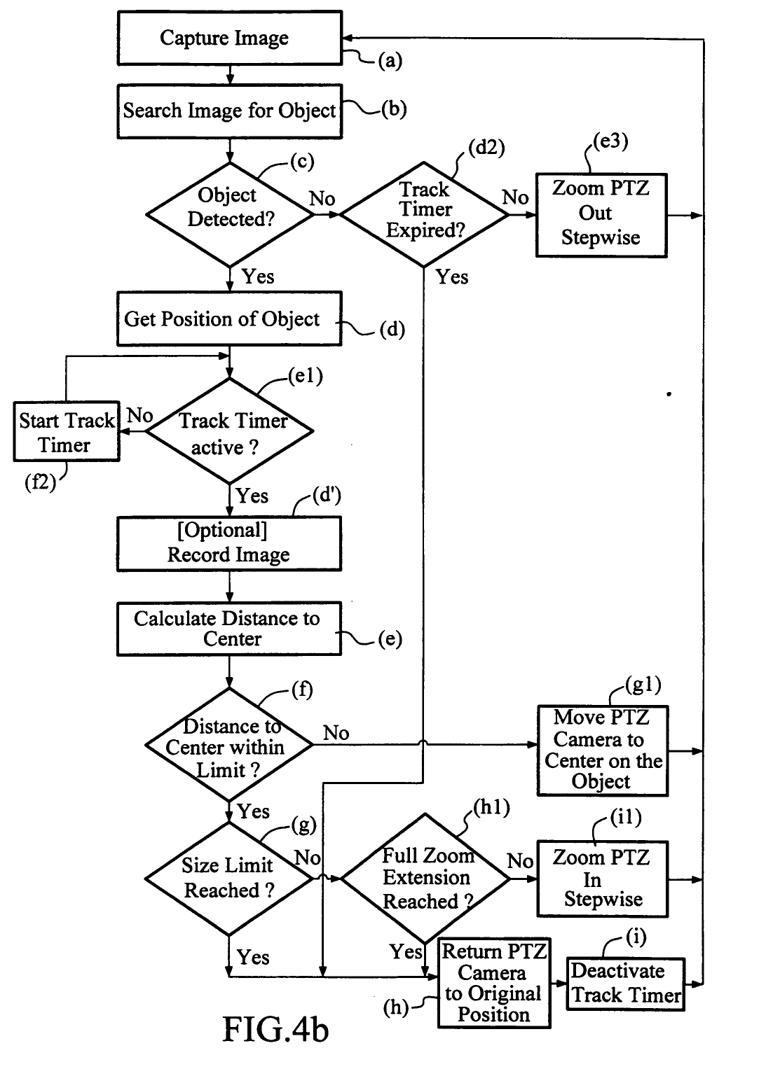

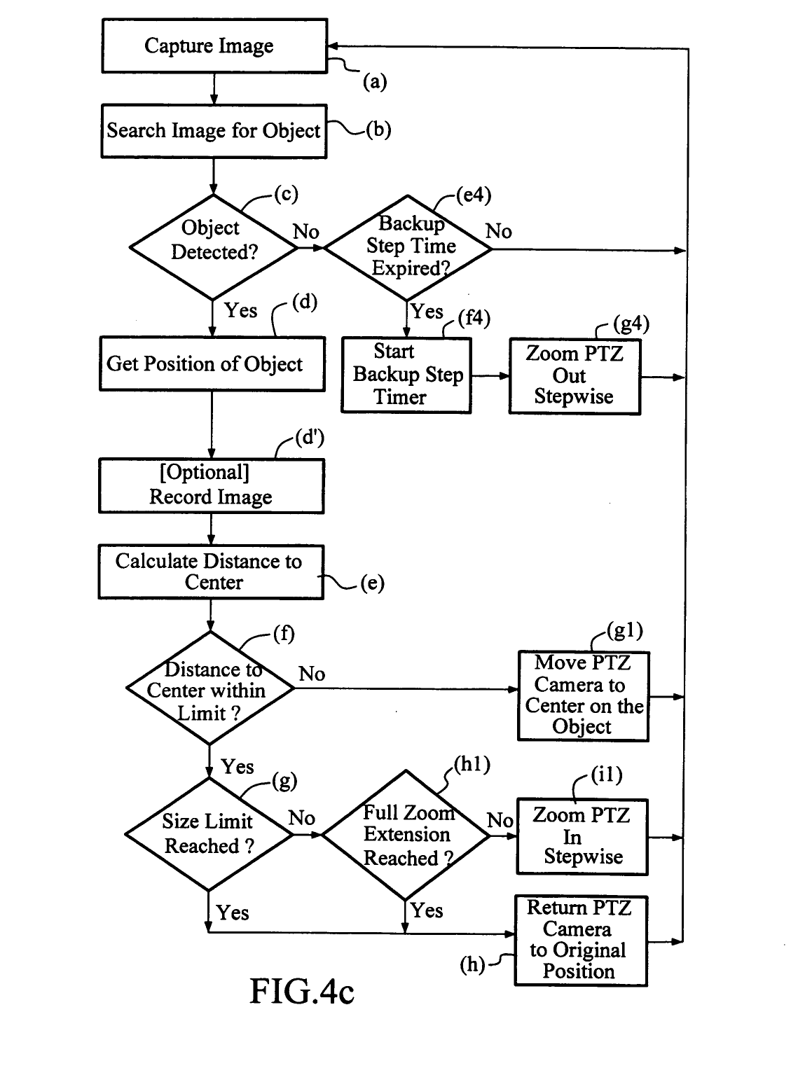

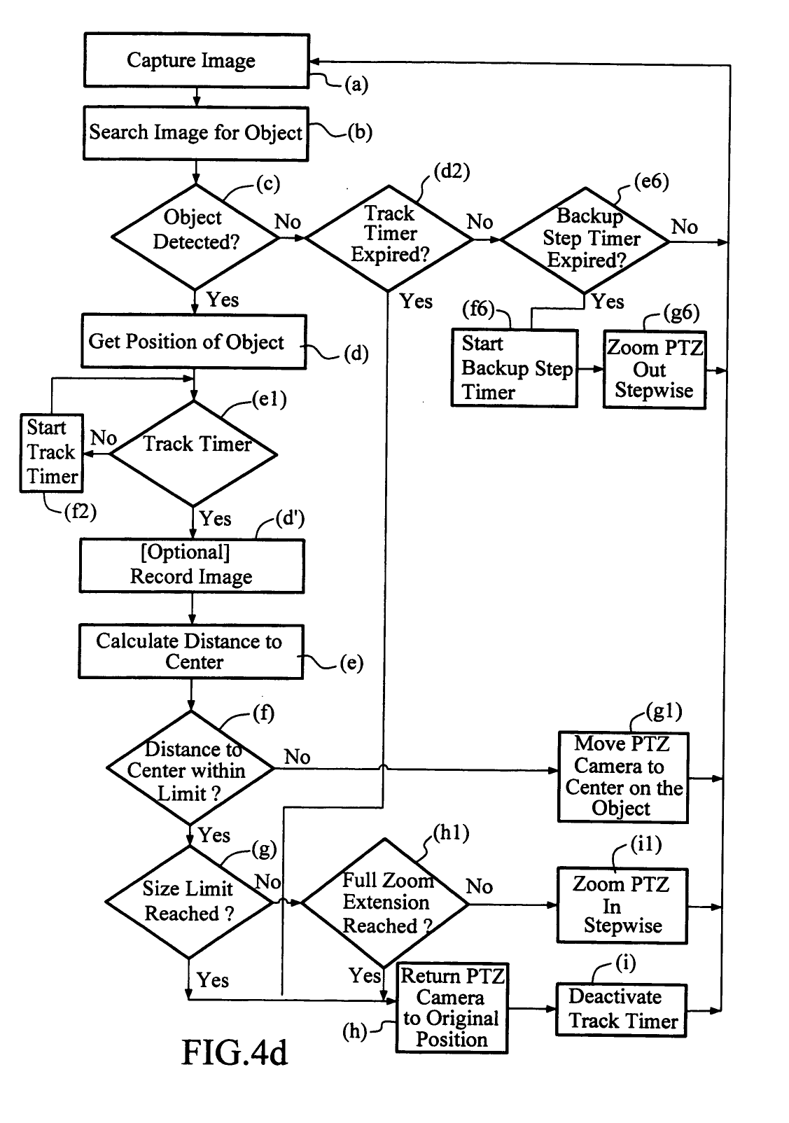

FIG. 4 discloses the detailed flow chart of a method of capturing zoom-in images of objects, including the relationships between all of the components and time, and may operate in a continuous loop by repeating the list of steps. The steps of the method detailed in FIG. 4 effectively delineate the process of isolating a single object from a scene or image and following that object, capturing images of the object along the way. Images are optionally recorded as the PTZ camera is slowly adjusted to keep the detected object in the center of the images and zooms in stepwise as long as the detected object stays within a certain predefined distance from the center of the images. When the camera zoom limit is reached, the object size in the images reaches the maximum predefined limit, or if the object is lost, the camera eventually returns to the original “home” position, repeating the process as desired. However, the mode of operation after losing the object may vary depending on application. In some instances, it might be desirable to have the camera return immediately to the home position when objects are lost, or in others, the camera could count the number of lost cycles before abandoning the search and returning home. The methodology chosen should not limit the essence of the zoom extraction step, which is to return the camera to the home position after determining that the object is truly lost.

Four different operational configurations of the method are shown for clarity. FIG. 4a is the basic configuration. FIG. 4b shows the method of FIG. 4a with an added Track Timer, which defines how long to continue the normal searching processes or zooming out stepwise, starting from the moment the initiating object was first detected. FIG. 4c shows the method of FIG. 4a with an added Backup Step Timer, which defines how long the system continues its search at a particular resolution for the currently-detected object before increasing the size of the view field by zooming out the PTZ camera in a stepwise manner. FIG. 4d shows the method of FIG. 4a and a combination of the two options shown in FIG. 4b and FIG. 4c, including both the Track Timer and a Backup Step Timer. In the present context, to “start” a timer is defined as meaning both to reinitialize the time to the predetermined value and to activate the timer function.

FIG. 4a includes both a primary pathway, annotated using base letters (a, b, c, . . . , i) and primary alternates (d1, g1, h1). Together, the primary and primary alternate pathways are essentially the same method as described in the description of FIG. 3, presented as a functional method. The following includes a description of the primary and primary alternate pathways of FIG. 4a.

Before executing the method, the system remains idle, where nothing happens. Upon starting, the method first executes step (a), capturing an image with a PTZ camera, step (b), searching for the object in the image and step (c), determining whether any instances of the object are detected. If the answer of step (c) is no (i.e., no object is detected), the method executes step (d1) to zoom the camera out stepwise, finally to its original or “home” position. The method then repeats steps (a), (b), (c) and (d1) in a loop, as long as no object is detected. In this mode, the system continuously searches the view field from its original or “home” position, which could be any camera position where the zoom is not fully extended but is typically the widest-angle, fully retracted zoom position.

If the answer to step (c) is yes (i.e., if any instances of the object are detected), the method executes step (d) to select an object and get the positional location of the selected object in any coordinate representation, such as rectangular or polar coordinates. The methodology used for selecting the object of interest in the case where multiple objects are detected may vary, but could include the object closest to the center or the first object detected during the search. Once the positional location of the object is obtained, the method executes step (e) to calculate the distance of the object to the center of the image. Next, the method executes step (f) to determine whether the distance is within a predetermined distance. If the answer of step (f) is no, the method executes step (g1) to move the PTZ camera to center on the object. Then the method starts the loop from step (a) again. On the other hand, if the answer of step (f) is yes, the method executes step (g) to determine whether size of the object reaches a predetermined size. If the answer of step (g) is yes, the method executes step (h) to return the PTZ camera to an original position. Then the method starts the loop from step (a) again. If the answer of step (g) is no, the method executes step (h1) to check whether the PTZ camera lens full zoom extension is reached. If the answer of step (h1) is no, the method executes step (i1) to zoom in the PTZ camera stepwise. Then the method starts the loop from step (a) again. Alternatively, if the answer of step (h1) is yes, the method executes step (i2) to return the PTZ camera to its original position. The method may then repeat again from step (a).

An optional step to record images, step (d′), can be added before step (e) of the method so as to record the high-resolution zoomed-in images at any stage of the process.

FIG. 4b is a representation of the method with a Track Timer included. The Track Timer is used for convenience to tell the system how long to continue searching, tracking, and zooming in on an object before giving up and abandoning the search. FIG. 4b fundamentally employs all of the same elements as described in FIG. 4a, with several steps added in between the previously described steps, and the step (d1) of FIG. 4a replaced with a new step (d2).

The method may add this functionality directly after obtaining the position of the object in step (d), by adding a new step (e1) to determine if the Track Timer is active. If the Track Timer is active, the method executes step (f1), proceeding to step (e) as before, otherwise, if the Track Timer is deactivated, the method instead executes step (f2) to start (activate) the Track Timer. The method then executes step (g2) (i.e., steps (e1) and (f1)), this time passing through directly to step (e). Step (d2) determines whether the Track Timer is over a predetermined time, or “deactivated”. If the answer of step (d2) is yes, the method executes step (e2), i.e., returning the camera to its initial position, and the method starts the loop from step (a) again. If the answer of step (d2) is no (i.e., the Track Timer is still active), the method executes step (e3) to zoom the camera out stepwise, finally to its original or “home” position. To complete the method, the Track Timer must be deactivated, in step (i) and step (j2), whenever the camera finishes its zooming and capturing functions and is deliberately sent back to an original position, as in step (h), step (e2) or step (i2).

FIG. 4c is a representation of the method with a Backup Step Timer included. The Backup Step Timer is used for convenience to tell the system how long to wait between steps when backing out to return to the original, or “home” position. FIG. 4c fundamentally includes all of the same elements as described in FIG. 4a, with several steps added to replace the step (d1) of FIG. 4a.

If an object is not detected in step (c), step (e4) determines whether a Backup Step Timer is over a fourth predetermined time that determines the length of time to search at a given resolution scale before abandoning the search at that scale and retracting the zoom lens stepwise. If the answer to step (e4) is yes (i.e. the Backup Step Timer is over the fourth predetermined time), the method executes step (f4) to start the Backup Step Timer. Then the method executes step (g4) to zoom out the camera stepwise to an original position. Otherwise, if the Backup Step Timer is not over the fourth predetermined time, the method executes step (f5), maintaining the PTZ camera in its current position.

FIG. 4d shows the method in yet another alternate embodiment that includes the addition of both the Track Timer and the Backup Step Timer to the method shown in FIG. 4a. This configuration is the most convenient for both limiting the overall search time and for controlling the frequency of backup steps during the zoom out process when the object is totally or temporarily lost. This configuration is essentially the same as that shown and described in FIG. 4b, except that step (e3) of FIG. 4b is replaced with a different set of steps.

If the Track Timer is not over a predetermined time in step (d2), the method executes step (e6), determining whether a Backup Step Timer is over a fourth predetermined time that determines the length of time to search at a given resolution scale before abandoning the search at that scale and retracting the zoom lens stepwise. If the answer of step (e6) is yes (i.e., the Backup Timer is over the fourth predetermined time), the method executes step (f6), starting the Backup Step Timer and step (g6), zooming out the PTZ camera stepwise to a final original “home” position. Otherwise, if the answer of step (e6) is no, executing step (f7), maintaining the current PTZ camera position.

### Camera Assignment System

This same invention may be implemented with one or more PTZ (zoom) cameras operating simultaneously, or in conjunction with a fixed camera. In this case, a primary camera, either fixed or PTZ, monitors the positions of the objects, while the method described herein is used to direct PTZ cameras (not shown in the drawings) to the appropriate locations to obtain high-resolution zoomed-in images. In this case, the PTZ cameras can operate under their own supervision after initial assignment, or they may work in a subordinate capacity to the main camera image control system. In these cases, the viewing fields of the primary and the PTZ cameras need to be mutually calibrated prior to activation.

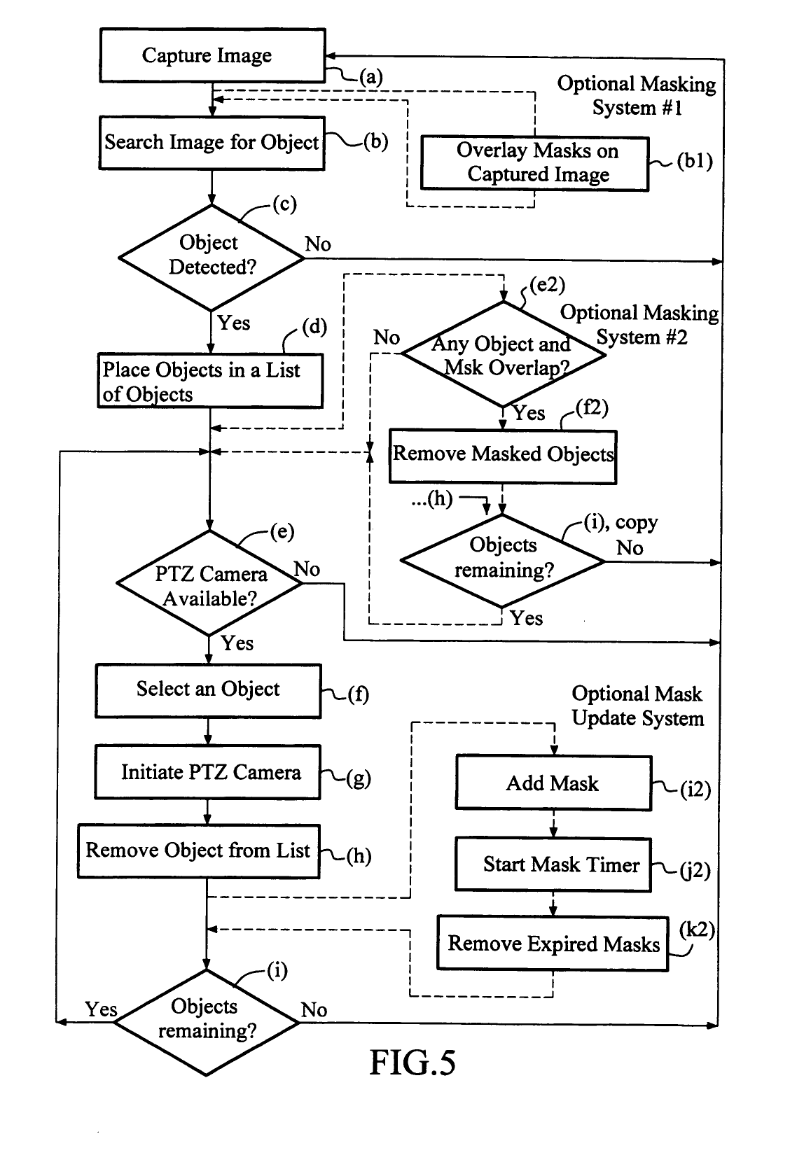

FIG. 5 discloses a method of assigning one or more systems as shown in FIG. 3 using a primary camera. Although a single object-capturing PTZ camera system as shown in FIG. 3 may act independently, it is often desirable to operate several systems simultaneously, to maintain a list of detected objects, or to apply a refreshable masking system to the original or “home” position image so that the same object is not tracked and captured repeatedly within a certain period of time. To do this, a primary camera is employed for initial detection of the objects, followed by a transfer of specific object-related information to the PTZ cameras used to obtain the zoom in images, using mutually calibrated visual fields. The primary camera in this case can be a separate camera, whether fixed or movable (PTZ), and can also be the same camera used for the object-capturing PTZ camera system as shown in FIG. 3. However, this method requires that the image captured is always that of the original “home” position.

Before executing the method shown in FIG. 5, the system remains idle, with nothing happening. Upon starting, the method first executes step (a), capturing an image with a primary camera, step (b), searching for the object in the image and (c) determining whether any existences of the objects are detected. If the answer of step (c) is no (i.e., no object is detected), the method then executes step (d1), i.e., executes step (a) again. The method then repeats steps (a), (b), (c) and (d1) in a loop, as long as no object is detected.

If the answer to step (c) is yes (i.e. any existences of the objects are detected), the method executes step (d), placing the detected objects in a list of detected objects. Then the method then executes step (e), determining if any systems as shown in FIG. 3 are available to capture the detected objects. If any of the systems is available, the method executes step (f), selecting the particular associated object to capture from the list of detected objects. However, if no system is available, the method executes step (f1), executing step (a) again. After executing step (f), the method executes step (g), initializing the system of capturing images, and step (h), removing the associated object from the list of detected objects. The method then executes step (i) to determine if any objects remain in the list of detected objects and, if so, executes step (j), i.e., executing step (e) again. Otherwise, if no objects remain in the list of detected objects, the method executes step (j1), or executing step (a) again.

The method of FIG. 5 also includes optional masking systems that can be applied to the general assignment method described above. By assigning a time-limited mask to every object associated with an object-capturing PTZ camera system, a list of masks is created that is used to keep track of the regions in the image initially occupied by previously captured objects. In this context, masks are defined as representations of two-dimensional sub-regions located within the original field of view of the overview camera in its initial, or “home”, position. For example, the information associated with a mask might be stored as four values (X,Y,W,H) which represent a rectangular area with its upper left corner at a coordinate position (X,Y) and a given pixel width (W) and height (H). Alternatively, the mask shapes could be circular or other shapes more representative of the particular object being detected. The type of mask chosen should not be confused with the essence of its function, which is to identify regions occupied by previously detected objects. Masks are eliminated when an associated Mask Timer goes over a second predetermined time that determines how long to wait before removing a mask from the list of masks. Using this method, various masking systems may be built from the masks. As drawn, FIG. 5 also includes a masking update method and two possible methods for masking which may be used in some embodiments, although other masking methods may be employed that fundamentally serve the same purpose of keeping track of previously identified objects so that the camera or cameras can select and capture zoom in images of other objects.

Initially, no masks are present, so the Mask Timers are deactivated. After the method removes an object from the list of detected objects in step (h) of FIG. 5, the method executes step (i2) to add a mask to the list of masks, and step (j2) starts a Mask Timer associated with the detected object to the list of masks, executes step (k2), removing mask(s) from the list of masks when the mask's associated Mask Timer is over a second predetermined time that determines how long to wait before removing a mask that is used to identify a previously identified object, and then executes step (l2), i.e. step (i). Effectively, if a mask remains in the list of masks, its Mask Timer is still active.

The method uses the first possible masking system included in the method of FIG. 5 directly after capturing the image in step (a) by executing step (b1), applying a mask overlay created from the list of masks onto the captured image, wherein masked regions effectively hide corresponding areas in the captured image and then continuing the method by executing step (b). In this case, the mask overlay is an image-blocking representation with the same physical dimensions as the original captured image, but blocks out the information from the original image in the regions occupied by any masks. “Blocking” in this context is defined as setting the image intensity data in that region to zero or an identical value, but could also be any other representation of image data that is not an object. In this way the original captured image that goes into the object detector component in step (b) lacks the information originally existing in the region of the mask.

The method makes use of the second possible masking system shown in FIG. 5 directly after step (d) by executing step (e2) to determine if any region in the image covered by a mask in a list of masks overlaps any region in the image occupied by an object in the list of detected objects by a predetermined threshold. This threshold could be the percentage of overlap, for example, where overlap in this case is defined as the portion of the two regions occupying the same location in the image. 100 percent overlap would mean that the mask and object regions are identical, while 30 percent overlap would mean that the object region only intersects with 30 percent of the region occupied by the mask, or vice versa.

If any region covered by a mask in a list of masks overlaps with any object region from the list of detected objects by the predetermined threshold, the method then executes step (f2), removing the respective objects from the list of detected objects, and executing step (g2), executing step (i). On the other hand, if none of the object regions in the list of detected objects overlap with any mask regions in the list of masks, the method executes step (f3), i.e., executes step (i) and continues the with the method.

### THE BEST MODE OF CARRYING OUT THE INVENTION

The best mode for the invention at this time is the face-detection application. In this case, a robust face-detection algorithm is used to detect faces of different sizes for the object detector. Since the size of the face is well defined, the limit at which to stop zooming the camera is known. Also, the face-detection algorithm is fast enough to update the tracked individual under continuous camera movement. In addition, the high-resolution images of faces captured in this manner are valuable for security applications, which was the original driving force behind the development of the system and method. Additionally, multiple face-capturing PTZ camera systems can be employed simultaneously from the same device as described here for improved surveillance and image recording.

Although the invention has been described with reference to specific embodiments, this description is not meant to be construed in a limiting sense. Various modifications of the disclosed embodiments, as well as alternative embodiments, will be apparent to persons skilled in the art. It is, therefore, intended that the appended claims will cover all modifications that fall within the true scope of the invention.

What is claimed is:

1. A system, comprising:
a pan, tilt, zoom (PTZ) camera for capturing a video stream in view;
an image-capture device for extracting and digitizing images from the video stream;
an object detector for detecting objects in the images from the image-capture device, determining the locations and sizes of the objects and sending the locations and the sizes of the objects to a selector;
the selector for choosing one of the objects and sending the location and size of the one of the objects to an assessor;
the assessor for determining the trajectories required to both align the one of the objects to the center of the image based on the current location of the one of the objects relative to the center and to maximize the size and resolution of the one of the objects according to the current size of the one of the objects, and for sending the trajectories to a translator;
the translator for converting the trajectories into a signal stream with a command format that a camera controller can understand and for sending the converted trajectories to the camera controller; and
the camera controller for moving and zooming the PTZ camera according to the signal stream,
thereby the PTZ camera moves to center on the one of the objects and captures zoomed-in images of the one of the objects from the video stream.

2. The system of claim 1, further comprising:
recording means for recording the zoomed-in images.

3. The system of claim 1, wherein the object detector uses a direct comparison algorithm.

4. The system of claim 3, wherein the direct comparison algorithm is a face-detection algorithm.

5. The system of claim 1, wherein the object detector uses a motion detection algorithm.

6. The system of claim 1, wherein the object detector initially uses a direct comparison algorithm to find the objects and then uses a template matching technique to continue detecting the objects.

7. The system of claim 1, wherein the object detector initially uses a direct comparison algorithm to find the objects and then uses a neural network technique to continue detecting the objects.

8. The system of claim 1, wherein the object detector initially uses a motion detection algorithm to find the objects and then uses a template matching technique to continue detecting the objects.

9. The system of claim 1, wherein the object detector initially uses a motion detection algorithm to find the objects and then uses a neural network technique to continue detecting the objects.

10. The system of claim 1, wherein the command format is in rectangular coordinates.

11. The system of claim 1, wherein the command format is in polar coordinates.

12. The system of claim 1, wherein the PTZ camera is a device capable of producing a constant stream of images.

13. The system of claim 12, wherein the PTZ camera is a video camera.

14. The system of claim 12, wherein the PTZ camera is a continuously activated still-frame camera.

15. A camera assignment system for assigning one or more systems of claim 1, comprising:
a primary camera for capturing a video stream in view;
a primary image-capture device for extracting and digitizing images from the video stream;
a primary object detector for detecting objects in the images from the primary image-capture device, determining the locations and sizes of the objects and sending the locations and the sizes of the objects to a primary selector;
the primary selector for choosing selected objects to capture from the objects detected by the primary object detector and sending the locations and the sizes of the selected objects to an assignor; and
the assignor for assigning the selected objects to the one or more assessors of the one or more systems of claim 1.

16. The camera assignment system of claim 15, wherein the primary camera and the PTZ cameras are mutually calibrated.

17. The camera assignment system of claim 15, wherein the primary camera is a device capable of producing a constant stream of images.

18. The camera assignment system of claim 17, wherein the primary camera is a video camera.

19. The camera assignment system of claim 17, wherein the primary camera is a continuously activated still-frame camera.

20. A method of using a system of claim 1, comprising the steps of:
(a) capturing an image with the PTZ camera;
(b) searching for the objects in the image;
(c) determining whether any existences of the objects have been detected;
(d) if any existences of the objects have been detected, selecting one of the objects and obtaining its location and size;
(e) calculating the distance of the one of the objects from the center of the image;
(f) determining whether the distance is within a predetermined distance;
(g) if the distance is within a predetermined distance, determining whether the size of the one of the objects reaches a predetermined size; and
(h) if the size of the one of the objects reaches a predetermined size, returning the PTZ camera to an original position.

21. The method of claim 20, further comprising the step of:
(i) deactivating a Track Timer.

22. The method of claim 20, where the object selected in step (d) is the object closest to the center of the captured image.

23. The method of claim 20, further comprising the steps of:
(h1) if the size of the one of the objects does not reach the predetermined size, checking whether the PTZ camera lens full zoom extension is reached; and
(i1) if the PTZ camera lens full zoom extension is not reached, zooming in the PTZ camera stepwise.

24. The method of claim 23, further comprising the step of:
(i2) if the PTZ camera lens full zoom extension is reached, returning the PTZ camera to an original position.

25. The method of claim 24, further comprising the step of:
(j2) deactivating a Track Timer.

26. The method of claim 20, further comprising the steps of:
(g1) if the distance of the one of the objects from the center of the image is not within a predetermined distance, moving the PTZ camera to center on the object.

27. The method of claim 20, further comprising the steps of:
(e1) determining whether a Track Timer is active; and
(f1) if the Track Timer is active, executing step (e).

28. The method of claim 27, further comprising the steps of:
(f2) if the Track Timer is deactivated, starting the Track Timer for a third predetermined time that defines how long to continue the search and zoom function for the object that was originally detected; and
(g2) executing step (e1).

29. The method of claim 20, further comprising the step of:
(d1) if no object is detected, zooming the PTZ camera out stepwise.

30. The method of claim 20, further comprising the steps of:
(d2) if the one of the objects is not detected, determining whether a Track Timer is over a third predetermined time that defines how long to continue the search and zoom-in function for the object that was originally detected; and
(e2) if the Track Timer is over the third predetermined time, returning the PTZ camera to an original position.

31. The method of claim 30, further comprising the steps of:
(e3) if the Track Timer is not over the third predetermined time, zooming out the PTZ camera stepwise.

32. The method of claim 20, further comprising the steps of:
(e4) if the one of the objects is not detected, determining whether a Backup Step Timer is over a fourth predetermined time that determines the length of time to search at a given resolution scale before abandoning the search at that scale and retracting the zoom lens stepwise;
(f4) if the Backup Step Timer is over the fourth predetermined time, starting the Backup Step Timer; and
(g4) zooming out the PTZ camera stepwise.

33. The method of claim 32, further comprising the step of:
(f5) if the Backup Step Timer is not over the fourth predetermined time, maintaining the current camera position.

34. The method of claim 30, further comprising the steps of:
(e6) if the Track Timer is not over the third predetermined time, determining whether a Backup Step Timer is over a fourth predetermined time that determines the length of time to search at a given resolution scale before abandoning the search at that scale and retracting the zoom lens stepwise;
(f6) if the Backup Step Timer is over the fourth predetermined time, starting the Backup Step Timer; and
(g6) zooming out the PTZ camera stepwise.

35. The method of claim 34, further comprising the step of:
(f7) if the Backup Step Timer is not over the fourth predetermined time, maintaining the PTZ camera in its current position.

36. The method of claim 20, further comprising the step of:
(d′) recording images one step prior to the execution of step (e).

37. A method of using a camera assignment system of claim 15, comprising the steps of:
(a) capturing an image with the primary camera;
(b) searching for objects in the image;
(c) determining whether any objects have been detected;
(d) if any objects have been detected, placing them in a list of detected objects;
(e) determining whether any of the one or systems of claim 1 is available;
(f) if one of the one or more systems of claim 1 is available, selecting an associated object from the list of detected objects;
(g) initializing the one of the one or more systems of claim 1;
(h) removing the associated object from the list of detected objects;
(i) determining if any objects remain in the list of detected objects; and
(j) if any objects remain in the list of detected objects, executing step (e).

38. The method of claim 37, wherein the associated object selected in step (f) is the object nearest to the center of the image.

39. The method of claim 37, further comprising the step of:
(d1) if no object is detected, executing step (a).

40. The method of claim 37, further comprising the step of:
(f1) if no system is available, executing step (a).

41. The method of claim 37, further comprising between the steps (a) and (b) a step of:
(j1) if no objects remain in the list of detected objects, executing step (a).

42. The method of claim 37, further comprising the steps of:
(b1) applying a mask overlay created from the list of masks onto the captured image, wherein masked regions effectively hide corresponding areas in the captured image.

43. The method of claim 37, further comprising between the steps (d) and (e) steps of:
(e2) determining if any regions in the image covered by masks in a list of masks and the regions in the image covered by detected objects in the list of detected objects overlap by a predetermined threshold;
(f2) if any regions in the image covered by masks in a list of masks and the regions in the image covered by detected objects in the list of detected objects overlap by a predetermined threshold, removing the respective objects from the list of detected objects; and
(g2) executing step (i).

44. The method of claim 43, further comprising the steps of:
(f3) if none of the regions in the image covered by masks in the list of masks and the regions in the image covered by detected objects in the list of detected objects overlap by a predetermined threshold, executing step (e).

45. The method of claim 37, further comprising the steps of:
(i2) adding a mask to the list of masks corresponding to the region occupied by the associated object;
(j2) starting a Mask Timer associated with the mask added to the list of masks;
(k2) removing mask(s) from the list of masks when the mask's associated Mask Timer is over a second predetermined time that determines how long to wait before removing a mask that is used to identify a previously identified object; and
(l2) executing step (i).

46. The method of claim 37, wherein the step of initializing the one of the one or more systems of claim 1 comprises:
capturing an initial image using the PTZ camera of the one of the one or more systems of claim 1;
transferring the calibrated size and positional information to the assessor of the one of the one or more systems of claim 1; and
using object size and positional information to initially align the object in the one of the one or more systems of claim 1.

47. The method of claim 37, wherein the primary camera and the one or more PTZ cameras are mutually calibrated.
